(19) United States
(12) Patent Application Publication
(10) Pub. No.: US 2008/0075056 A1
(43) Pub. Date: Mar. 27, 2008

(54) MOBILE WIRELESS DEVICE AND PROCESSES FOR MANAGING HIGH-SPEED DATA SERVICES

(76) Inventor: Timothy THOME, Spring Valley, CA (US)

Correspondence Address: KYOCERA WIRELESS CORP., P.O. BOX 928289, SAN DIEGO, CA, 92192-8289, US

(21) Appl. No.: 11/534,579

(22) Filed: Sep. 22, 2006

(51) Int. Cl. H04B 7/216

(52) U.S. Cl. 370/342

(57) ABSTRACT

A wireless mobile device is provided that is capable of operating a high-speed data application. The mobile device detects and uses speed information to adjust the operating characteristics of the high-speed data application. The desired operating characteristics are defined in a speed profile, which may be stored at the local device or on the associated network. Using the speed profile, the mobile device may enable, disable, or restrict specific features and functions responsive to the detected speed. In operation, the mobile device has a speed detection circuit that detects a current speed. In some cases, the detected speed may be filtered to better characterize speed. The mobile device sets one or more speed flags according to the detected speed. When a request is made to operate a high-speed data application, the mobile device checks the speed flag, and operates the high-speed data application according to the speed settings in the speed profile.

### TECHNICAL FIELD

The field of the present invention is wireless mobile devices that are enable for high-speed data services, and process operating on those devices. More particularly, the present invention relates to hardware circuits and processes for managing a high-speed data service request for a mobile device.

### BACKGROUND

Mobile devices have become an important part of modern life. For example, wireless mobile handsets are widely accepted throughout the world, and are widely used for entertainment and business purposes. Many of these devices have been enabled to send and receive data using high-speed data channels. The availability of high-speed data for wireless mobile devices has enabled a broad range of mobile applications. For example, high-speed Internet access, live video streaming, and interactive gaming all rely upon the robust availability of high-speed data connections. These high-speed data connections may be provided through a broadband connection, and are provided by current communication standards such as CDMA2000, WCDMA, UMTS, and GPRS. Other data communication standards may include WiMax, WiBro, WiFi, or broadcast standards such as MediaFlo, DMB, or DVB-T/H, for example. High-speed data connections may also be provided using commercial or military proprietary protocols. Other standards are continually emerging and advancing for providing yet higher rates of data communications with mobile wireless devices. As these advanced data networks become available, additional users will begin using and enjoying the benefits of high-speed data with their wireless mobile devices.

To support these advanced applications, wireless mobile devices also have advanced to provide further application support, as well as provide for advanced user input and presentation devices. For example, even wireless mobile handsets, which historically have been used primarily for making voice phone calls, now typically have video cameras, large video displays, and high-quality speakers. These advanced input and presentation devices provide additional convenience for the user, as well as allow for more efficient and effective communication with high-speed data applications. Some wireless handsets even include sophisticated text input, joysticks, and user controls for allowing a user to interact with browsers, gaming controls, and video. These high-speed and data intensive applications act to more fully immerse or pull in the user. For example, these applications may require more sophisticated and more time sensitive interaction, or may require the user more carefully monitor the display for video or other information. Accordingly, these new networks and devices provide for a more complete, robust, and stimulating work or entertainment environment. Further, as consumers become aware of the advantages and appeal of these new high speed, high data intensity applications, additional consumer demand is fueled. These consumers are now demanding and expecting higher performance applications, and providers are responding with these more fully enabled networks, devices, and applications. Also, as the providers invest in the infrastructure, hardware, and application resources necessary to implement his high-speed data networks, the providers are increasingly advertising the benefits of their use, in this way, use of high-speed data networks through more wireless devices is expected to continue to explode.

However, these new high-speed applications and devices present an the opportunity for misuse by consumers. For example, it would generally be considered unsafe for the driver of an automobile to be concurrently watching high-speed streaming video on their mobile device while driving. Public awareness of these risks has fortunately increased in the recent past, for example, by the movement toward use of hands-free car kits and handsets when making calls. Also, manufacturers of high-quality video devices may position those devices to avoid distracting the driver, for example, car manufacturers position video monitors in the backseat so that the driver is not distracted by playing of DVD news. Unfortunately, if the media is being presented on a wireless mobile device, an opportunity exists for the driver to unsafely view video, play games, or otherwise interact with high-speed data appliances.

### SUMMARY

Briefly, the present invention provides a wireless mobile device that is capable of operating a high-speed data application. The mobile device detects and uses speed information to adjust the operating characteristics of the high-speed data application. The desired operating characteristics are defined in a speed profile, which may be stored at the local device or on the associated network. Using the speed profile, the mobile device may enable, disable, or restrict specific features and functions responsive to the detected speed. In operation, the mobile device has a speed detection circuit that detects a current speed. In some cases, the detected speed may be filtered to better characterize speed. The mobile device sets one or more speed flags according to the detected speed. When a request is made to operate a high-speed data application, the mobile device checks the speed flag, and operates the high-speed data application according to the speed settings in the speed profile.

In a specific example, the mobile wireless device locally stores a speed profile that defines how a high-speed data application should adapt its operation response to speed. The mobile device continually detects a current speed using an integral or network-assisted GPS system. The detected speed is used to set one or more speed flags, which may, for example, indicate a short-term and a long-term speed. When the network or mobile device requests the device operate a high-speed data application, the mobile device uses the speed flag(s) and speed profile to enable, disable, or restrict operation of the high-speed application. For example, if a high rate of speed is indicated, the mobile device may restrict a navigation application to voice-only prompts, or may disable the viewing of any streaming video. In another example, when a slow speed is detected, full operation may be enabled. An over-ride function may be provided that warns the user that a high-rate of speed is detected, and then has the user input a password or answer a challenge to enable more functionality. A logging or tracking feature may be used to record speed, application, and over-ride information.

### BRIEF DESCRIPTION OF THE DRAWINGS

FIG. 1 is a block diagram of a wireless mobile device in accordance with the present invention.

FIG. 2 is a diagram of alternative speed flags in accordance with the present invention.

FIG. 3 is a diagram of alternate speed profiles in accordance with the present invention.

FIG. 4 is a flowchart of a method managing high speed data requests for a in accordance with the present invention.

FIG. 5 is a flowchart of a method managing high speed data requests for a in accordance with the present invention.

### DETAILED DESCRIPTION

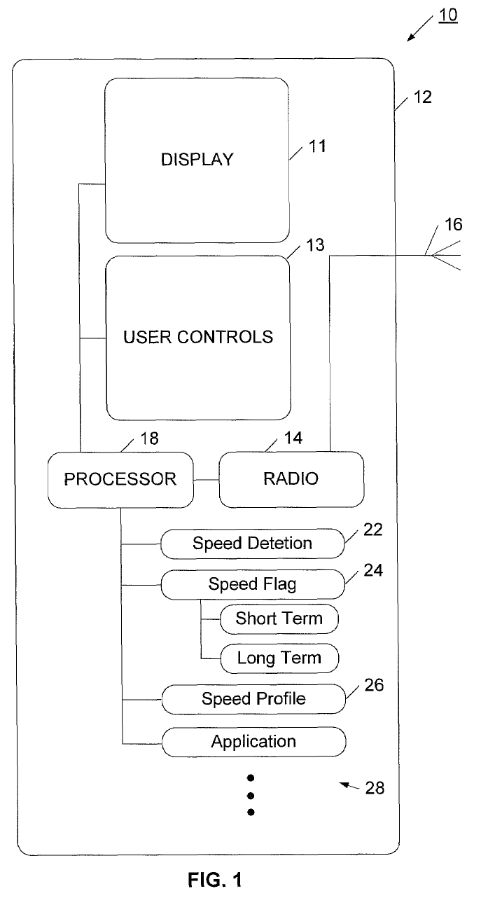

Referring now to FIG. 1, wireless mobile device 10 is illustrated. Wireless device 10 may be, for example, a wireless mobile handset for making and receiving voice phone calls. Advantageously, wireless mobile device 10 also may be enabled for high-speed data applications. These high-speed data applications may include, for example, navigation applications, playing high-speed streaming video, receiving video files, and interactive gaming. It will be appreciated that many high-speed applications are currently available and many others will be offered as technology, devices, and networks advance. Although wireless mobile device 10 will be discussed with reference to a mobile wireless handset, it will be understood that wireless mobile device 10 may also be a portable personal data assistant, a portable Internet appliance, a laptop or notebook computer configured with high-speed wide area communication capability, or other mobile wireless device capable of establishing a high-speed data channel using a infrastructure carrier. The wireless mobile device may also be incorporated into another larger product, such as a vehicle. Mobile wireless device 10 has antenna 16 attached to or inside housing 12. Antenna 16 couples to radio 14 for establishing both voice and data communication with a supporting infrastructure system. Both radio 14 and the supporting infrastructure system (not shown) typically operate compliant with a communication standard such as CDMA, WCDMA, CDMA2000, UMTS, EDGE, GPRS, or other communication standard. Other data communication standards may include WiMax, WiBro, WiFi, or broadcast standards such as MediaFlo, DMB, or DVB-T/H, for example. High-speed data connections may also be provided using commercial or military proprietary protocols. It will be appreciated that communication standards evolve over time, and other standards will be introduced in the future. Mobile wireless device 10 also has processor 18 for assisting in establishing voice calls, data calls, and for operating applications. In one example, these applications may include high-speed data applications such as the capture and display of video information, performing interactive gaming functions, or transmitting, receiving, or operating on large data files. For example, one of the applications may include an application for selecting and downloading a wide variety of games, position location applications, or business applications. In another example, the high-speed data application may include requiring significant user input from input controls 11, or may require constant attention to display 13, such as when playing a real-time interactive game.

Wireless mobile device 10 has speed detection module 22 for detecting the rate of speed for wireless mobile device 10. For example, speed detection module 22 may be a local GPS receiver which locally receives satellite information, and calculates location and speed information. In another example, the speed detection module 22 may be an assisted GPS system which locally receives GPS information, but cooperates with a network asset for determining position and speed information. In this way, the speed detection module 22 receives satellite information, transmits certain satellite information to the network asset, and then receives speed and location information from the network through radio 14. In another example, speed detection module simply receives speed and location information from the network. In these cases, the network determines location and speed information for mobile wireless handset 10 by one or more processes such as tracking the wireless device through cell transitions, monitoring power level signatures, or using a triangulation process using multiple base stations. In yet another example, speed detection module may detect a Doppler shift in a communication or other signal.

Wireless mobile device 10 also has speed flag 24 for maintaining and reporting current speed information. In one example, speed flag 24 may be stored locally in a memory of wireless mobile device 10, and in another case may be requested and retrieved from a network infrastructure asset. Speed flag 24 may also simply be a digital logic state indicating when a predefined speed has been exceeded. In another example, speed flag 24 is a multi-byte data value capable of indicating several speed states. For example, the speed flag 24 could indicate when a speed is undeterminable, when a speed is stationary, or when a speed is moving. In another example, speed flag may indicate particular speeds, or ranges of speeds. For example, speed flag may indicate that the phone is moving between 2 and 5 mph, possibly indicating the phone is being carried by a person walking. In another example, the speed flag may indicate the phone is moving between 20 mph and 50 mph, possibly indicating the phone is being carried by someone bicycling or riding in a car. In some cases, speed flag 24 may even have a state for showing that the mobile device is traveling at a very high rate of speed, such as 200 mph. In this case, the indicator would provide information that the mobile wireless handset is operating in, for example, a high-speed train or on an airplane. Speed flag 24 may also include multiple flags. For example, speed flag 24 may include a short-term flag indicating a speed factor determined from short time period intervals. For example, a short term flag may indicate a near instantaneous speed or an average speed over a few seconds. Depending on the specific application, other short-term time periods may be used. A long-term speed may also be determined which may average speed over a longer period, such as several minutes, and may include filtering to reduce short-term transient effects. For example, a GPS signal may occasionally provide an errant location data, so filter may be used to reduce the effects of such incorrect location data. It will be appreciated that the type of filter and filter factors may be selected according to application specific requirements or that the filter and filter factors may also be selected or adapted according to detected conditions such as signal quality, speed, and the type of high-speed application being operated.

Wireless mobile handset numeral 10 also has speed profile 26. Speed profile 26 may be specific to an individual application, or may apply to all applications operating on the wireless mobile handset. For example, a global speed file may be made that defines that no high-speed data wireless communications will be allowed when the speed is over, for example, 35 mph. In another example, speed profile 26 allows for a local user override, so that after proper warning, a local user may activate a high-speed service. A speed profile may also be set for individual applications that may more fully define the characteristics for application, or may provide specific changes to a global profile. For example, a streaming video application may have a profile set to allow full speed motion video only when speeds are under 25 mph, and allow for no high-speed video transmission, even in an override attempt. However, the system may be set to provide individual images to the local user even at higher rates of speed, and may allow for the download to occur so that the file may be played at a later time. This could allow, for example, a video segment to be downloaded while a driver is moving quickly through traffic, and then allow the driver to view the short video when stopped. In another example, a navigation application may provide a full video navigation support when the user is not moving or moving slowly, but may be limited to voice-only direction once a minimum speed is exceeded. In mobile wireless handset 10, multiple applications 28 are likely to be available. These high-speed applications may include Internet browsing, interactive gaming, video streaming, or other high-speed applications. It will also be understood that additional high-speed data applications are likely to evolve will be available in the future.

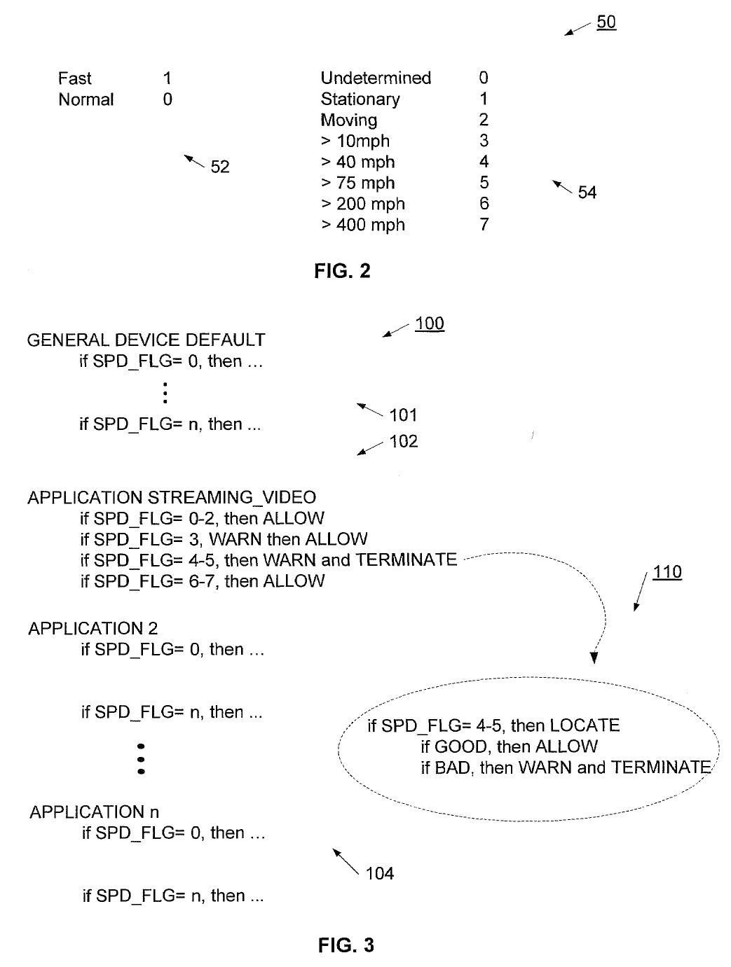

Referring to a FIG. 2, alternative examples 50 for speed flags are illustrated. Speed flag 52 include a single bit logic state showing whether the mobile unit is operating at a slower speed or at a fast speed. In this way, the mobile wireless device's high-speed data events may be managed according to whether the mobile device is moving slowly or quickly. In another example, a multi-byte speed flag 54 is used for indicating speed. The multi-byte value 54 may be a nibble, a byte, or a multi-byte value depending upon the granularity or detail of speed information. In one example, flag 54 may include a value indicating that speed is undetermined, or that the mobile device is stationary, and then have various specific speeds or ranges of speeds. In this way, the control of specific applications and the mobile wireless device may be more finely adjusted according to speed indication. In one example, the speed flag is continually updated by the wireless mobile device during operation. The update rate for the wireless flag may be static, or may be adapted according to application specific needs. Also, the speed flag may include an indication of short-term speed as well as long-term speed. In this regard, the long-term speed may be averaged over a definable period of time, and may have filtering to reduce transient or short-term effects. The speed flag may also be set upon making a request for a high-speed event. In this way, when an application requests a high-speed data event, the wireless device may quickly respond by allowing the event, disallowing the event, allowing the event in a restricted or limited manner, or otherwise apply a speed profile for that application. It will be understood that the speed flag may be set through local operations, or may be set through cooperation with the network asset.

Referring now to FIG. 3, speed profile 100 is illustrated. Speed profile 100 may have a global area 101 for defining a global default characteristic for handling high-speed data events. In this way, the default characteristics would be used unless specific application characteristics are used to override, or a user overrides with specific commands or passwords. As illustrated in 100, application 102 is a streaming video application, and uses flag 54 as a comparison value. Accordingly, if flag 54 is set to 0-2, then the full motion video is allowed. If the flag is set to 3, than the user is first warned and then full-motion streaming video is allowed. However, if speed 4-5 is indicated, then the streaming video is not allowed in any case. In the case where speed is 6-7, streaming video is allowed again, since these speeds indicate that the user is traveling in a high speed train, airplane, or other high-speed carrier. Other applications 104 will also have specific associated speed profile definitions. Another alternative 110 shows that an application may also be set according to received location information. In this way, both speed and location information may be used to set characteristics for high-speed data events. For example, application 102 shows that if speed 4-5 is indicated, the no high-speed streaming video is allowed. However, alternative 110 shows that if speed 4-5 is indicated, then an additional comparison may be performed to check if the wireless mobile device is in an allowed area. For example, even if speed is indicated at 4-5, if the user is in a specific approved location, then full speed motion video may be allowed. For example, if the user is in an area reserved for train traffic, then the user of the wireless device is allowed full access to streaming video, as it may be assumed that the user is a passenger on a train.

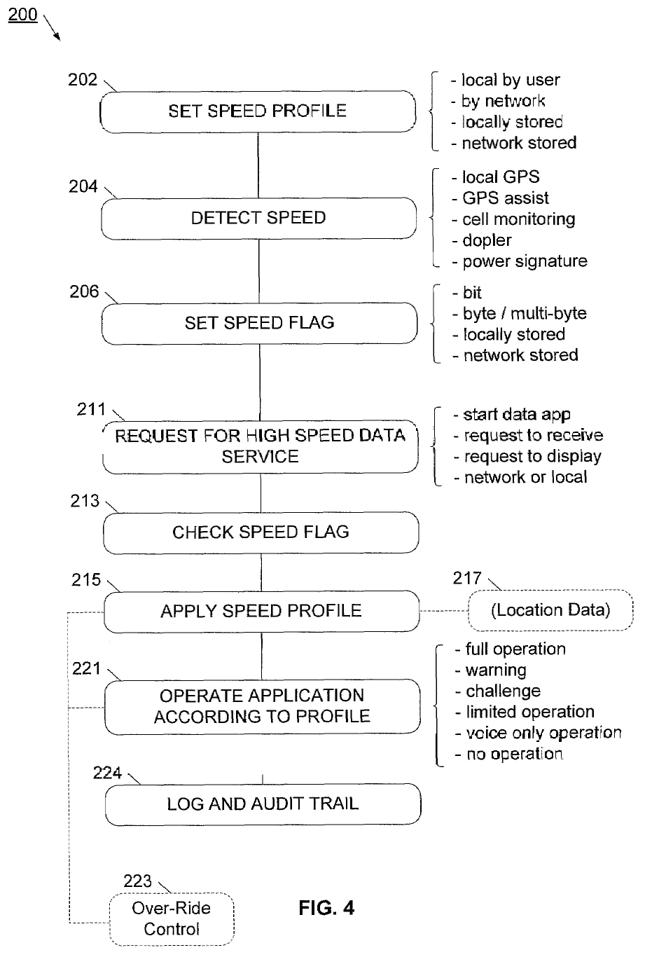

Referring now to FIG. 4, a process for managing requests for high-speed data events on a wireless mobile device is illustrated. Speed process 200 has a user, network, or application set a speed profile as shown in block 202. The speed profile may be locally defined by a user of the wireless mobile handset, may be set by the network and locally stored in the device, set by the network and stored at a network asset, or set according to the operation of a particular application. It will be understood that the profile may be set a default for the device itself, and then individual applications may adjust these default settings. The wireless mobile device continually detects speed as shown in block 204. This detection may be done according to a local GPS circuit which receives satellite information and calculates local speed and location information, or may be done with the cooperation and assistance of network assets. For example, the mobile device may receive satellite information, and then transmit timing and ephemeral information to the network, and receive more specific location and speed information in return. It will also be understood that the network may determine the speed of the mobile device, and communicate the speed to the mobile wireless device using the device's radio system. In another example, speed is detected using Doppler shift, either from a communication signal or another available signal source. The detected speed is used to set a speed flag as shown in block 206. The speed flag may be a single logic bit, a multi-byte value, or other informational field. It will also be understood that multiple speed flags may be used. The speed flag is typically stored locally on the wireless mobile device, although it may be stored on the network and transmitted to the mobile device upon request.

When the wireless mobile device receives a request for high-speed data service as shown in block 21 1, the mobile device will retrieve the speed flag from its local memory or from the network. The high-speed data service request may be a request to start an application requiring or preferring high-speed data transmissions, a request to receive and display high-speed information, or a request to participate in an interactive game. It will be appreciated that many high-speed data service events may be used. In a specific example, a high speed data request may be a request to display high-speed video information from a network asset. In another example, the high-speed data service event may be a request to display video information from local memory to the display. In such a case, the high-speed data event uses a high-speed data transmission to download and locally store a large amount of information, and then the request to display the video file occurs at a later time.

Upon receiving a request for high-speed data service, which may be made locally, through network cooperation, or through a combination of both, the local device checks the speed flag as shown in block 213. Upon checking the speed flag, the local device is made aware of the current rate of speed of the local device. Accordingly, the local device may apply the speed profile as shown in block 215. The speed profile may be a general speed profile setting default settings for the device, or may be applied according to specific requested data events or applications. It will also be understood that optional location data 217 may be used to further apply the speed profile. The local wireless device operates the high-speed application according to the speed profile and current speed as shown in block 221. For example, the local wireless device may operate the application according to its full operational characteristics, may warn the user or request input from the user before full operation, may have some challenge tasks or questions to confirm the user is able to properly interact the device, may provide for limited or restricted operation of the application, or may provide for no operation at all. In one example of limited operation, a wireless device may have requested the display of high-speed video information. Instead of immediately streaming and playing information, the application may enable download of the video file, but restricts displaying of the video file until a later time when speed has been reduced.

In another example, the user desires to access a video navigation system. Such a system may automatically provide location information, for example using a GPS receiver or other location-aware device. Then, using either local or network resources, the application will provide turn by turn directions to the user. Preferably, the wireless device provides video or image information to the user. However, when the wireless device detects that the user is moving faster than a minimum speed, the speed profile may disable the video or image portion of the navigation application. Accordingly, when operating above a minimum speed, the navigation system may be limited to audio alerts only. In this way, the user would not be tempted to divert his or her their eyes to view a display. However, the application may interrogate the user to see if the user is able to safely input a password or answer a challenge question. If the user is able to successfully input the required information, the navigation application, after giving proper warning, may proceed to display its full video or image capability. The user is acknowledgment of safe operating condition, as well as the users challenge input may be recorded contract for verification purposes. In this way, the application maintains a log of warnings and acknowledgments by the user.

In some cases, a local user override 223 may be provided. In this way, a user may be advised of safe use requirements, and if the user determines they are in a safe operating condition, then they proceed to fully operate and interact with the application.

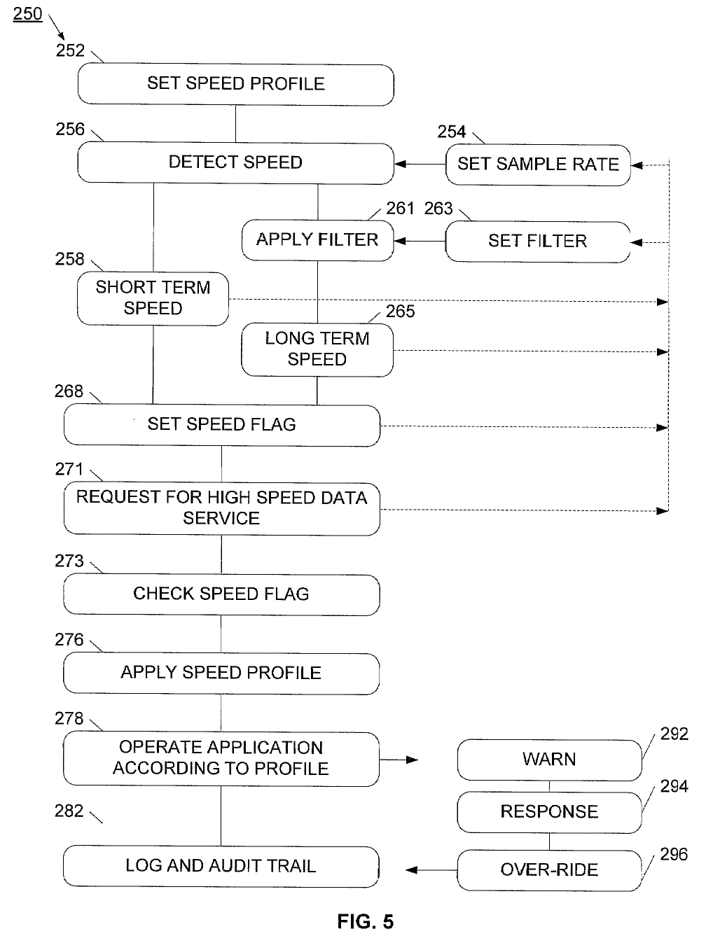

Referring now to FIG. 5, another method for handling requests for high-speed data applications is illustrated. Method 250 is similar to method 200 described with reference to FIG. 4, so will not be described in detail. Method 250 has a speed profile 252 maintained locally or at a network location. The speed profile specifically defines how the mobile wireless device will respond when an application requests a high-speed data service. The wireless mobile device is able to detect a speed as shown in block 256. The speed may be detected from time to time responsive to external stimulus, or may be set to be updated periodically. For example, the wireless device may be set to update the current speed more or less often depending upon the capability of the wireless device or the type of high-speed application being requested. Using the detected speed, a short-term speed 258 may be determined. For example, this short-term speed may be the instantaneous speed detected in block 256, or may be an average speed over a short number of samples. The short-term speed may be filtered, for example using a known time-integration process, or may have other filtering techniques applied. The short-term speed may be used to set a short-term speed flag as shown in block 268. A filter 261 may also be applied to detected speed, and an average speed determined over a longer period of time as shown in block 265. The filter may, for example, filter out transient or spurious data points in detected speed, or may allow for a better understanding of a user's movement. The long-term speed may, for example, average speeds over several minutes, thereby enabling the wireless device to more clearly assess the user's movement. The long-term speed filter may be, for example a known time-integration process, or may have other filtering techniques applied. The long-term speed is also used to set a speed flag as shown in block 268. It will be appreciated that more than two flags may be set, and that historical speed information may be captured.

At some point a request is made for access to a high-speed data service as shown in block 271. The application or wireless device then checks the speed flag or flags as shown in block 273. The speed file associated with the particular application is applied as shown in block 276, and the application is operate according to profile as shown in block 278. In one example, a user requests to use a navigation system. At the time the user makes a request, the user is stopped at a stop light. Accordingly, the detected speed and the short-term flag may show the user is stationary, and therefore might be able to safely view full video navigation information. However, the long-term speed flag would show that the user is traveling at a speed more indicative of car travel, and therefore should not be viewing the video display of a wireless device. Accordingly, by using both the short-term speed flag and the long-term speed flag, a more accurate assessment of user condition is established, allowing the wireless device and application to make better decisions as to when to warn the user or restrict use of the application. It will be appreciated that the various speed flags may be analyzed and used in a wide variety of applications.

In one case, the wireless device and application may determine that the user should be restricted from using a particular high speed data application. However, the user may actually be in a safe condition, such as being a passenger in a car. To determine if the user is in a safe position, the wireless device and application may first warn 292 the user of the possible danger in using the wireless device while driving, and then request 294 that the user, if it can be done safely, input a password or answer a challenge question. If a proper response is made, then the application proceeds to over-ride the restriction as shown in block 296, and allows the application to proceed normally. The detected speed, warning, and response may be captured and logged as shown in block 282. This log provides an accurate audit trail of the interaction between the network, wireless device, application, and the user. Such an accurate audit trail would encourage responsible user behaviors.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A mobile wireless device, comprising:
a speed detection circuit;
a speed flag set by the speed detection circuit;
a speed profile for an application; and
a processor operating the application, and performing the steps of:
receiving a request for a high speed data event;
checking the speed flag to determine a speed; and
operating the application according to the speed profile.

2. The mobile wireless device according to claim 1, wherein the speed detection circuit cooperates with a filter.

3. The mobile wireless device according to claim 1, further including a long-term speed flag and wherein the speed flag is a short-term speed flag.

4. The mobile wireless device according to claim 1, wherein the speed detection circuit further comprises a local GPS receiver or a local network-assisted GPS circuit.

5. The mobile wireless device according to claim 1, wherein the speed detection circuit further comprises a circuit for receiving a speed indication from a network infrastructure.

6. The mobile wireless device according to claim 1, wherein the speed detection circuit further comprises a circuit for deriving a speed by receiving and processing a signal to detect a Doppler shift.

7. The mobile wireless device according to claim 1, wherein the speed flag is a bit, a nibble, a byte, or a multi-byte data value.

8. The mobile wireless device according to claim 1, further including a local memory for locally storing the speed flag, or a retrieval circuit for retrieving the speed flag from a network asset.

9. The mobile wireless device according to claim 1, wherein the speed flag has indicators for a plurality of speed ranges.

10. The mobile wireless device according to claim 1, wherein the speed flag has an indicator for an undetermined speed.

11. The mobile wireless device according to claim 1, wherein the speed profile has a plurality of profiles according to specific applications.

12. The mobile wireless device according to claim 1, wherein the speed profile allows the high speed data event if the speed is under a limit.

13. The mobile wireless device according to claim 1, wherein the speed profile allows for limited operation of the high speed data event if the speed is over a limit.

14. The mobile wireless device according to claim 1, wherein the speed profile disables operation of the high speed data event if the speed is over a limit.

15. The mobile wireless device according to claim 1, wherein the mobile wireless device is a mobile wireless device operating according to CDMA, CDMA2000, WCDMA, UMTS, GPRS, or EDGE.

16. The mobile wireless device according to claim 1, wherein the mobile wireless device is a mobile wireless device operating a radio compliant with WiMax, WiBro, WiFi, MediaFlo, DMB, or DVB-T/H.

17. A method operating on a wireless mobile device, comprising:
providing a speed profile;
setting a speed flag according to a detected speed;
receiving a request from an application for a high-speed data event;
checking the speed flag to determine a speed responsive to receiving the high-speed data request; and
operating the application according to the speed profile.

18. The method according to claim 17, wherein the speed profile is defined by a user of the wireless mobile device or is defined by the provider of the application.

19. The method according to claim 17, wherein the speed profile is defined locally at the wireless mobile device or is defined remotely at a network asset.

20. The method according to claim 17, wherein the speed profile is stored locally at the wireless mobile device or is stored remotely at a network asset.

21. The method according to claim 17, wherein the step of setting the speed flag further comprises using a local GPS receiver or a local GPS receiver that is assisted by a network asset.

22. The method according to claim 17, further including setting a long-term speed flag, and wherein the speed flag is a short-term speed flag.

23. The method according to claim 17, wherein the speed flag is a bit, a byte, or a multi-byte value.

24. The method according to claim 17, further including the step of filtering the detected speed, and using the filtered speed to set the speed flag.

25. The method according to claim 17, wherein the step of receiving the request from the application further comprises receiving a request to start a high-speed data application, a request to receive high-speed data, or a request for a high-speed data channel.

26. The method according to claim 17, wherein the speed profile further includes location information, and the step of operating the application further comprises receiving the location information to adjust operating characteristics.

27. The method according to claim 17, wherein the step of operating the application further comprises receiving override information from a user of the wireless mobile device.

28. The method according to claim 27, further including the step of logging the override information.

29. The method according to claim 17, wherein the step of operating the application includes using a high-speed data channel compliant with CDMA, CDMA2000, WCDMA, UMTS, GPRS, EDGE, WiMax, WiBro, WiFi, MediaFlo, DMB, or DVB-T/H.
